(19) United States
(12) Patent Application Publication
(10) Pub. No.: US 2024/0104579 A1
(43) Pub. Date: Mar. 28, 2024

(54) REPURPOSING OF CLOUD SERVICE PROVIDER INFORMATION SYSTEM RESOURCES INSTALLED AT A REMOTE CUSTOMER LOCATION

(71) Applicant: Intel Corporation, Santa Clara, CA (US)

(72) Inventors: Mario Jose DIVAN, Hillsboro, OR (US); Marcos E. CARRANZA, Portland, OR (US); Francesc GUIM BERNAT, Barcelona (ES); Cesar Ignacio MARTINEZ SPESSOT, Hillsboro, OR (US); Mateo GUZMAN, Beaverton, OR (US)

(21) Appl. No.: 18/533,510

(22) Filed: Dec. 8, 2023

(51) Int. Cl. G06Q 30/015; H04L 41/0823

(52) U.S. Cl. CPC G06Q 30/015; H04L 41/0823

(57) ABSTRACT

A method is described. The method includes a service provider accessing data indicating that at least a portion of an information systems infrastructure that is managed by the service provider and is installed at a tenant's location to perform information services for the tenant is available to perform information services for entities other than the tenant. The method includes the service provider providing information services to at least one of the entities with the portion of the information systems infrastructure.

### BACKGROUND

With the emergence of cloud computing, cloud service providers are seeking ways to better utilize their increasingly expanding information system resources.

### BRIEF DESCRIPTION OF FIGURES

FIG. 1 depicts a traditional cloud service provider (CSP);

FIG. 2 shows CSP infrastructure resources installed at remote CSP customer location;

FIG. 3 shows a portion of the remote CSP infrastructure resources being allocated for customers other than the customer at whose location the remote CSP infrastructure resources reside;

FIG. 4 shows multiple respective portions of multiple remote CSP infrastructure resources being allocated for customers other than the customers at whose respective locations the remote CSP infrastructure resides;

FIG. 5 shows a method performed by a CSP;

FIG. 6 shows another method performed by a CSP;

FIG. 7 shows a data center;

FIGS. 8a and 8b shows respective depictions of an IPU.

### DETAILED DESCRIPTION

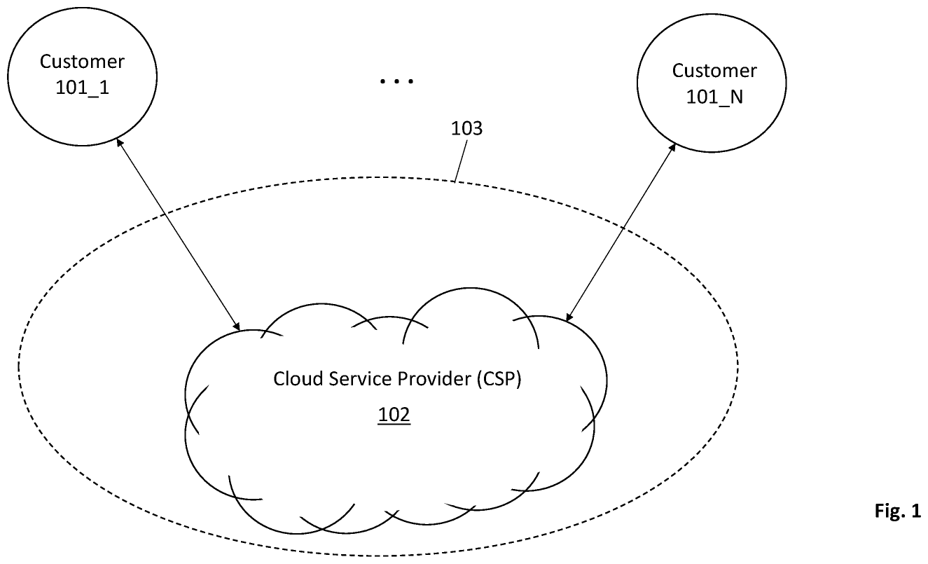

FIG. 1 shows a traditional cloud computing environment. As observed in FIG. 1, the information processing and/or storage demands of multiple customers 101_1 through 101_N are serviced by a cloud service provider 102 (“CSP”). Here, the customers 101_1 through 101_N send requests for specific information services tasks (e.g., processing and/or storage tasks) over one or more networks 103 to the CSP's information systems infrastructure 102 (such as one or more data centers). Here, a CSP's information systems infrastructure can be referred to with various terms such as processing and/or storage (“processing/storage”) infrastructure, information services resources, processing/storage resources, information system resources, CSP infrastructure, CSP resources, CSP installed resources, and the like.

Traditionally, as depicted by FIG. 1, the customers' respective locations 101_1 through 101_N are remote relative to the CSP's processing/storage infrastructure 102. As such, the customers' requests and the CSP's responses to them can traverse significant geographic distances over the respective network(s) 103 between the CSP 102 and the customers 101_1 through 101_N. Typically, different customers 101_1 through 101_N are different corporate or government entities and the CSP is a different corporate or government entity from the customers 101_1 through 101_N.

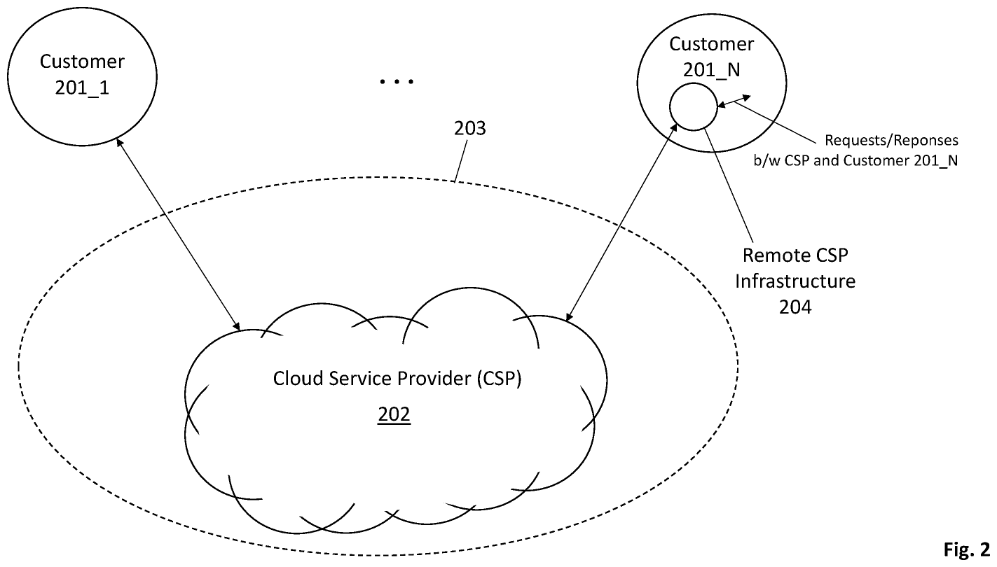

According to a new paradigm, observed in FIG. 2, CSP information processing/storage infrastructure (also referred to as information syste204 is being migrated out to various customer locations. The remote infrastructure 204 is operated (and commonly owned) by the CSP 202, but, is devoted for the use of the customer 201_N (“the tenant”) whose location is where the remote infrastructure 204 resides.

Here, for instance, a customer 201_N may observe better CSP performance with the infrastructure 204 that is installed at its physical location rather than the CSP's primary infrastructure 202, e.g., because the propagation time of requests/responses through the network(s) 203 that separates the customer 201_N from the CSP's primary infrastructure 202 is negated. Additionally or in combination, the customer 201_N may believe there are fewer security risks associated with the infrastructure 204 that is located at the customer's premises than with the CPS' primary infrastructure 202, e.g., because requests/responses with highly sensitive information are not passed through the network(s) 203 that separates the customer 201_N from the CSP's primary infrastructure 202.

Examples of CSPs that provide for remote, on-premise customer installations of the CSP's processing/storage infrastructure include Amazon's AWS Outpost, Microsoft's Azure Stack, Google Cloud's Anthos, Alibaba's Private Cloud, and Huawei Cloud Stack.

In certain circumstances, however, it may make sense to devote at least a portion of the CSP infrastructure that is at a first customer (“tenant's”) location and is nominally dedicated to the first customer (the “tenant”) to a second, different customer and/or the CSP. Here, the CSP and customers other than first customer are understood to be entities other than the tenant (notably, one or more of the customers other than tenant (entities other than the CSP and the first customer) can also be a tenant having CSP infrastructure installed at their respective location(s)).

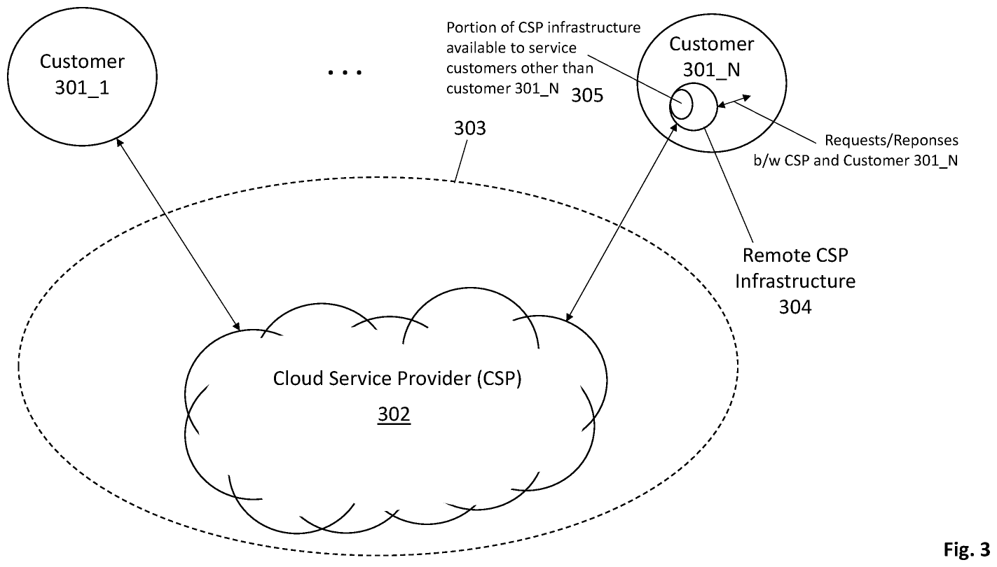

As observed in FIG. 3, a portion 305 of the infrastructure 304 at customer 301_N's location, is dedicated to service requests CSP customers other than 301_N. Here, for example, if the contractual relationship between customer 301_N and the CSP 302 is based upon customer 301_N making monthly payments for the use of the CSP's remote infrastructure installation 304 at customer 301_N's premises, and if customer 301_N fails to make payment, the CSP can begin to devote the processing/storage resources 304 at customer B's location to other (reliably paying) customers. So doing not only continues the monetization of the infrastructure 304 at customer 301_N's location when monetization from customer 301_N has come into question, but also, warns customer 301_N that customer 301_N's use of the CSP infrastructure 304 at customer 301_N's location is in jeopardy.

In another situation, customer 301_N may be underutilizing the CSP infrastructure 304 resources at customer 301_N's location, while, e.g., at the same time, the CSP's primary infrastructure 302 is being over-utilized. In this case, servicing the respective requests submitted by one or more of customers other than customer 301_N with the processing/storage resources 304 located at customer 301_N's location, rather than with the CSP's primary processing/storage resources 302, essentially “relieves the pressure” being applied to the CSP's primary processing/storage resources 304.

As the CSP's combined infrastructure is more efficiently utilized and/or the CSP's customers are better serviced. That is, if customer 301_1 submits requests to the CSP when the CSP's primary infrastructure 302 is being over utilized, customer 301_1 may observe reduced comparative CSP response times if the requests are serviced by the CSP's remote infrastructure 304 at customer 301_N's location rather than the CPS's primary infrastructure 302 (because, if the customer 301_1's requests were instead serviced by the CSP's primary infrastructure, many other requests from other customers would precede (and therefore need to be serviced before) customer 301_1's requests).

Note that power consumption can be used as a criteria in conjunction with, or instead of, CSP resource utilization. That is, for example, the CSP can justify repurposing remote CSP resources for the use of customers other than the customers at whose respective locations the remote CSP reside if the CSP determines that its primary infrastructure is consuming too much power while the remote CSP resources are not consuming very much power.

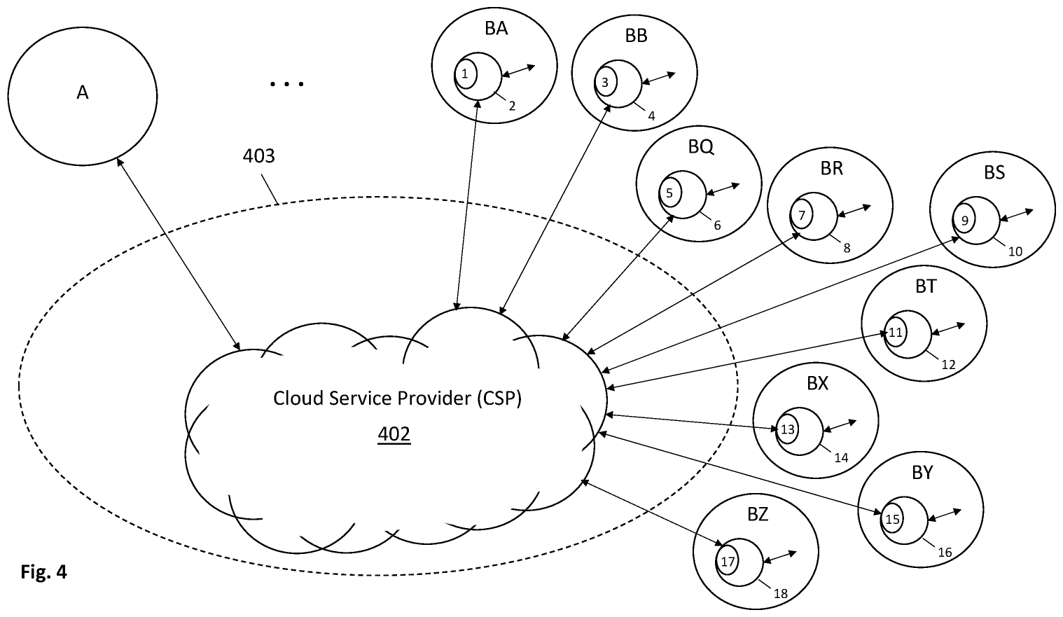

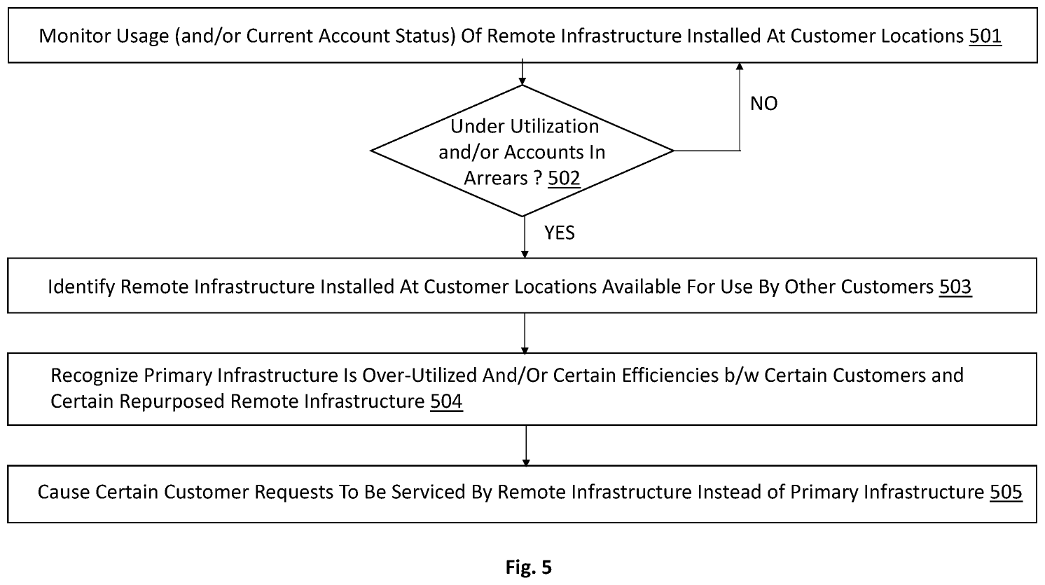

FIGS. 4 and 5 pertain to a process by which a CSP causes customer requests that would nominally be handled by the CSP's primary processing/storage infrastructure 402 to instead be handled by instances of CSP processing/storage infrastructure 2, 4, 6, 8, 10, 12, 14, 16, 18 that have been respectively installed at the remote, on-premise locations of other customers BA, BB, BQ, BR, BS, BT, BX, BY and BZ.

In the example of FIG. 4, the CSP's infrastructure includes primary processing/storage resources 402 and additional, remote CSP processing/storage resources 2, 4, 6, 8, 10, 12, 14, 16, 18 that have been installed at the respective remote locations of a number of customers BA, BB, BQ, BR, BS, BT, BX, BY and BZ. The primary processing/storage resources 402 can be centralized (e.g., within a tight cluster of one or more data centers) or distributed (e.g., across a plurality of geographically dispersed data centers) or a combination thereof.

As explained above, customer requests are nominally serviced with the CSP's primary infrastructure 402 with the exception of customers BA, BB, BQ, BR, BS, BT, BX, BY and BZ who have their request (or at least certain types of requests) nominally serviced by the CSP infrastructure 2, 4, 6, 8, 10, 12, 14, 16, 18 that has been installed on their respective premises.

As observed in FIG. 5, the CSP regularly monitors 501 the usage (and/or current account status) of the remote resources 2, 4, 6, 8, 10, 12, 14, 16, 18 by their respective customers BA, BB, BQ, BR, BS, BT, BX, BY and BZ. The monitoring 501 can include accessing data, such as receiving telemetry information, e.g., from the remote infrastructure installations 2, 4, 6, 8, 10, 12, 14, 16, 18, that describes what resources are being used and/or to what extent the resources are being used at the remote infrastructure installations 2, 4, 6, 8, 10, 12, 14, 16, 18.

When such monitoring reveals that one or more of the customers BA, BB, BQ, BR, BS, BT, BX, BY and BZ are underutilizing their on premise infrastructure 2, 4, 6, 8, 10, 12, 14, 16, 18, and/or, are not current on their respective payments for their on premise infrastructure 2, 4, 6, 8, 10, 12, 14, 16, 18, the CSP will determine 503 that a certain amount of the CSP resources at the remote locations of the under-utilizing/in-arrears customer are available for use by one or more customers (e.g., customer A) other than the customer(s) that is/are under-utilizing and/or is in-arrears with respect to its on-premise infrastructure.

In the particular example of FIG. 4, after a particular assessment 501, the CSP determines 502 that: 1) customers BA, BQ and BX are under-utilizing their on-premise CPU processing resources 2, 6, 14 and have timely paid their invoices to the CSP; 2) customers BB, BR and BY are under-utilizing their on-premise mass storage resources 4, 8, 16 and have timely paid the CPS's invoices; 3) customers BS and BT are under-utilizing their on-premise CPU processing and mass storage resources 10, 12 and have timely paid their invoices to the CSP; 4) customer BZ has not timely paid the CSP's invoices for use of the CSP infrastructure 18 installed on customer BZ's premises; and, 5) all other customers with remote CSP infrastructure installations are not under-utilizing their on-premise resources and have timely paid the CSP's invoices.

Based on this determination 502, the CSP next identifies 503: 1) certain CPU processing resources 1, 5, 13 at the locations of customers BA, BQ and BX that are eligible to be repurposed for servicing CPU processing requests issued by customers other than customers BA, BQ and BX, respectively; 2) certain mass storage resources 3, 7, 15 at the locations of customers BB, BR, and BY that are eligible to be repurposed for servicing mass storage requests issued by customers other than customers BB, BR and BY, respectively; 3) certain CPU processing and/or mass storage resources 9, 11 at the locations of customers BS and BT that are eligible to be repurposed for customers other than BS and BT, respectively; 4) certain CPU processing and mass storage resources 17 at the location of customer BZ that are eligible to be repurposed for the use of customers other than customer BZ.

In various embodiments, concurrent with the above assessment 502 and identification 503 of the CSP's remote resources, the CSP can also recognize 504 that its primary infrastructure 402 is being over-utilized, and/or, certain efficiencies can be gained by pairing certain customer requests with certain ones of the repurposed remote resources 1, 3, 5, 7, 9, 11, 13, 15, 17.

The factors by which the CSP determines whether or not the CSP's primary resources 402 are over-utilized can vary from implementation to implementation. For example, numbers of incoming customer requests, processing/storage requirements needed to service incoming customer requests, and/or power requirements needed to service incoming customer requests (and/or other customer load parameters) can be accumulated over time and compared to the respective capacity of the CSP's primary infrastructure 402.

If the customer load approaches, meets or surpasses some threshold of the capacity of the CSP's primary infrastructure (or some component therefore, e.g., CPU resources, mass storage resource's, etc.), the CSP can determine that its primary infrastructure 402 is being over-utilized, which, in turn, causes the CSP to consider the remote resource 1, 3, 5, 7, 9, 11, 13, 15, 17 installed at certain customer locations BA, BB, BQ, BR, BS, BT, BX, BY and BZ that have been deemed eligible for repurposing the requests of customers other than the customers where the remote infrastructure resides.

The factors by which the CSP can determine whether or not there is a particular efficiency between certain remote CSP infrastructure that is deemed available for use by customers other than the customer whose premises where the remote infrastructure resides can include, for example, geographic and/or network proximity between the premises of the customer where the remote CSP infrastructure resides and the other customer, availability of specific resources at the remote CSP infrastructure (e.g., a particular type of processor and/or application software program) and a demonstrated need for the specific resources by the other customer (e.g. the other customer frequently issues requests that need the specific type or processor and/or application software program).

With respect to the former, geographic proximity and/or network proximity (e.g., fewer nodal hops between the requesting customer and the remote CSP infrastructure than between the requesting customer and the CSP's primary infrastructure 402), the requesting customer is apt to observe faster response times from the CSP's remote infrastructure than from its primary infrastructure.

With respect to the later, pairing a customer having a specific (e.g. unique) need with the specific (e.g., unique) resources that satisfy that need are also apt to keep the CSP's performance in-line with the customer's expectations. Here, for example, referring to the example of FIG. 4, if customer A submits requests to the CSP that are CPU processing intensive (e.g., a specific type of application software program is requested), the CSP can pair the remote on premise CPU processing resources 1, 5, 13, 9, 11, 17 of any of customers BA, BQ, BX, BS, BT and BZ to service the requests. By contrast, if customer A submits requests to the CSP that are mass storage intensive, the CSP can pair the remote on premise processing resources 3, 7, 15, 9, 11, 17 of any of customers BB, BR, BY, BS, BT and BZ to service the requests. Further still, if customer A submits requests that are CPU processing and mass storage intensive, the CSP can pair the remote on premise processing resources 9, 11, 17 of any of customers BS, BT and BZ to service the request.

With a justification for servicing customer needs with remote CSP resources 504, the CSP scrutinize the incoming customer requests against the pool of available remote resources and causes 505 specific customer requests to be serviced by suitable remote CSP resources.

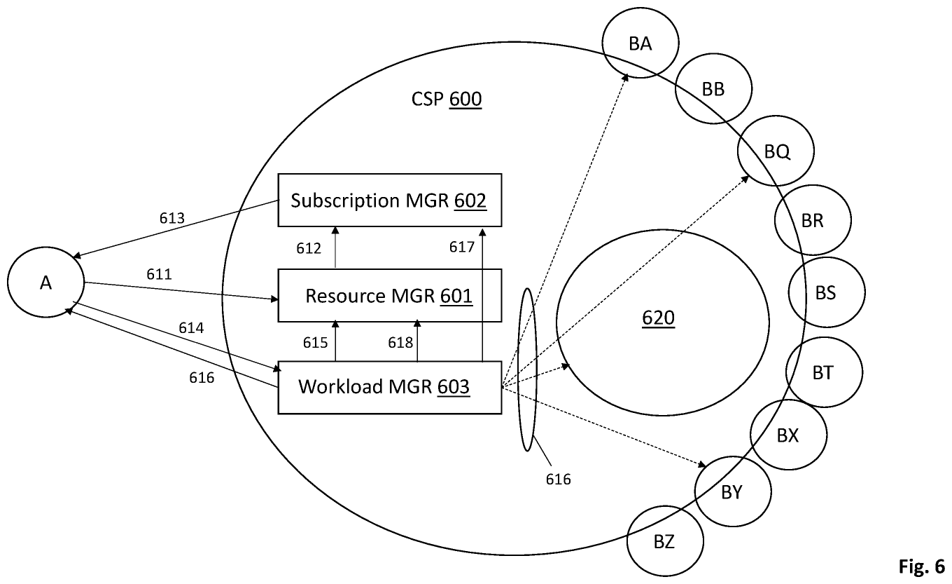

According to one embodiment, observed in FIG. 6, the CSP's primary infrastructure 620 (and/or one or more remote customer premise infrastructure installations) include: 1) a resource manager 601; 2) subscription manager 602; and, 3) a workload orchestrator 603.

As described in more detail immediately below, in view of the process of FIG. 5, the resource manager 601 can monitor usage of CSP infrastructure at the remote customer locations 501, determine if any of the remote customer installations are being under-utilized 502, determine which specific CSP resources at remote customer locations are made available for other users 503 and determine whether the CSP's primary infrastructure 620 is being under-utilized 504.

The subscription manager 602, by contrast, determines the current account status of remote customers having CSP infrastructure installations 501 and if any of these customers are in-arrears 502. As such, the resource manager 601 and the subscription manager cooperatively perform processes 501 and 502.

The workload orchestrator 603 recognizes certain efficiencies 504 between certain customers and certain remote CSP infrastructure that has been made available for customers other than the customer where the infrastructure resides, and, causes 505 the certain customer requests to be serviced CSP remote infrastructure rather than the CSP's primary infrastructure 620. As such, the resource manager 601 and the workload orchestrator 603 cooperatively perform process 504 of FIG. 5.

According to the embodiment depicted in FIG. 6, the resource manager 601 is informed of the available remote resources (and the functions they are capable of executing), e.g., remote customer locations BA, BQ, BX, BS, BT and BZ for CPU processing resources, remote customer locations BB, BR, BY, BS, BT and BZ for mass storage resources, etc. The resource manager 601 can further understand what functions are available at which remote locations (e.g., what software applications are available at which customer locations available CPU processing resources). Here, the resource manager 601 can access data (e.g., receive telemetry information), e.g., from the remote infrastructure installations, that describes what resources are being used and/or to what extent the resources are being used at the remote infrastructure installations.

When customer A issues a request 611, the resource manager 601 receives the request and determines what resources are available to service the request. The resource manager 601 can make the determination from an analysis of the customer's request, the customer's request can enumerate the specific resources that are needed to service the request, some combination of these, etc.

Notably, certain requests can request that “lengthy” processes be performed. For example, customer A can request the CSP 600 to execute a process having, e.g., a first phase that is CPU processing intensive, a second phase that is mass storage intensive, etc. The resource manager 601 is responsible for determining which CSP primary 620 and/or remote customer locations are available to service which phases of the requested process. Thus, the resource manager 601 is free to consider not only available remote customer resources but also available resources within the CSP's primary infrastructure 620 to determine whether or not the CSP has the resources to execute the customer's requested process.

If the resource manager 601 determines that the CSP 600 has the resources to execute the request, the resource manager notifies 612 the subscription manager 602 of the request. The subscription manager 602 determines the CSP's fee for performing the request (e.g., based on a service level agreement (SLA) with customer A) and notifies 613 customer A that the CSP 600 has the resources to perform the request. The notification 613 to customer A can include the fee for processing the request, the estimated time to complete the request (which, e.g., the resource manager 601 can provide insight to the subscription manager 6012 for based upon, e.g., queuing delays for the request's different functions/resources based on current demand, etc.).

After receiving the notification 613, customer A sends a formal request 614 to the CSP's workload orchestrator 603 to perform the request. The workload orchestrator 603 determines/schedules which specific CSP resources will execute the request's various functions, e.g., from the available pool of resources for each function as determined by the resource manager 601. Upon determining/scheduling which resources are to execute the requested process, the orchestrator 603 notifies 615 the resource manager 601 so that the resource manager 601 understands which resource are being consumed to execute the requested process. The workload orchestrator 603 then causes the request to be serviced by invoking 616 certain functions at certain resources (including one or more remote customer resources) in an appropriate sequence (e.g., phases).

Upon completion of the request's process, the orchestrator 603 sends 616 the resultant of the request to customer A, notifies 617 the subscription manager 602 of the successful execution of the process (so that it is recorded for billing purposes, records, etc.) and notifies 618 the resource manager 601 of the completion of the process (so that the resource manager 601 understands that the resources used to execute the process are now free to be reassigned).

In various embodiments the CSP 600 can decide to configure a particular customer, e.g., customer A, to use the remote resources of another customer, e.g., BA. For example, if customer A exhibits heavy usage of a particular application software program and the application software program is installed at a customer BA's location and is deemed available for use by customers other customer BA, the CSP 600 can configure the orchestrator 603 (or other function) to regularly/repeatedly forward requests from customer A that invoke the application (or the application and other applications/functions) to the resources at customer BA's location.

To further the configuration, the CSP 600 can move persisted data belonging to customer A that the application (and/or other functions) refer to when servicing customer A's requests from some mass storage location. e.g., within the CSP's primary infrastructure 620 to mass storage resources on customer BA's premises. So doing tightly couples customer A's persisted data to the, e.g., CPU processing resources at customer BA's location that will refer to the persisted data when servicing customer A's requests.

In various embodiments, the customer (A) whose requests are serviced with resources located on the premises of another customer (any of BA, BB, BQ, BR, BS, BT, BX, BY and BZ) is a corporate or government entity A that is a different corporate or government entity than the corporate or government entities BA, BB, BQ, BR, BS, BT, BX, BY and BZ at whose premises the CSP's remote infrastructure resides and where the customer's requests (or some portion thereof) are serviced. That is, customer A and customers BA, BB, BQ, BR, BS, BT, BX, BY and BZ are different corporate or government entities. Moreover, the CSP 600 can be a different corporate or government entity than the respective corporate or government entities of customers A and BA, BB, BQ, BR, BS, BT, BX, BY and BZ. That is, customer A, customers BA, BB, BQ, BR, BS, BT, BX, BY and BZ and the CSP 600 are different corporate or government entities.

Different corporate or government entities can have different Internet domain names that, e.g., a domain name service (DNS) resolves to IP addresses having different network prefixes. That is, customer A has a different domain name (e.g., “ABC.com”) than customer BA (“RST.com”), and, the CSP has a different domain name (e.g., “XYZ.com”) that both customer A and customer BA. Such different domain names are typically resolved by a DNS server to different IP addresses having different network prefixes that, e.g., uniquely identify the (respective gateways to) different networks of the different entities on the Internet. That is, the network prefix of the IP addresses that target (a gateway to) customer A's network is different than the network prefix of the IP addresses that target (a gateway to) customer BA's network, and, the network prefix of the IP addresses that target (a gateway to) the CSP's network is different than the respective network prefixes of the respective IP addresses that respectively target (a gateway to) customer A's network and (a gateway to) customer BA's network.

In order to address security issues, in various embodiments, when a customer's on premise infrastructure is used to service another customer's requests, both customers information should be protected from each other. This can generally be achieved through isolation. Here, for instance, the different customers are allocated processing resources (e.g., CPU cores) and memory locations that are isolated from one another (e.g., customer A's allocated processing cores cannot write/read to/from customer BA's allocated memory region and vice-versa). Likewise, the applications of one customer can be configured to operate in one or more different containers than the applications that the other customer are configured to operate in.

As described above, in various embodiments, the CSP can begin to allocate CSP resources at a remote customer's location to other customers if the remote customer fails to make payment, or, because the remote CSP resources are being under-utilized. In the case of the later, the CSP and customer can agree that the customer is to be compensated, in some way, if the CSP allows other customers to use the CSP infrastructure at the customer's remote location. In various embodiments, such compensation can include any/all of the CSP giving the customer invoicing credit, reducing the customer's invoiced fees, making a monetary payment to the customer, giving credit towards future services provided by the CSP, giving credit towards a future upgrade of CSP infrastructure at the customer's location, etc.

Although embodiments above have emphasized CPU resources and mass storage resources as components of the CSP's infrastructure, the CSP's infrastructure can be composed of other components such as various forms of accelerators (e.g., GPUs, Artificial Intelligence (AI) training accelerators, AI inference engine accelerators, image processors, encoding/decoding accelerators, crypto-mining accelerators, etc.). Thus, accelerator resources can also be repurposed from a remote customer's CSP installation for the use of other customers as described at length above.

In various embodiments remote CSP resources that are deemed available for repurposing are allocated for crypto-mining at one or more remote customer locations. The crypto-mining may be performed on behalf of CSP customers other than the customers at whose locations the remote CSP resources reside, or, crypto-mining entities that are not otherwise customers of the CSP.

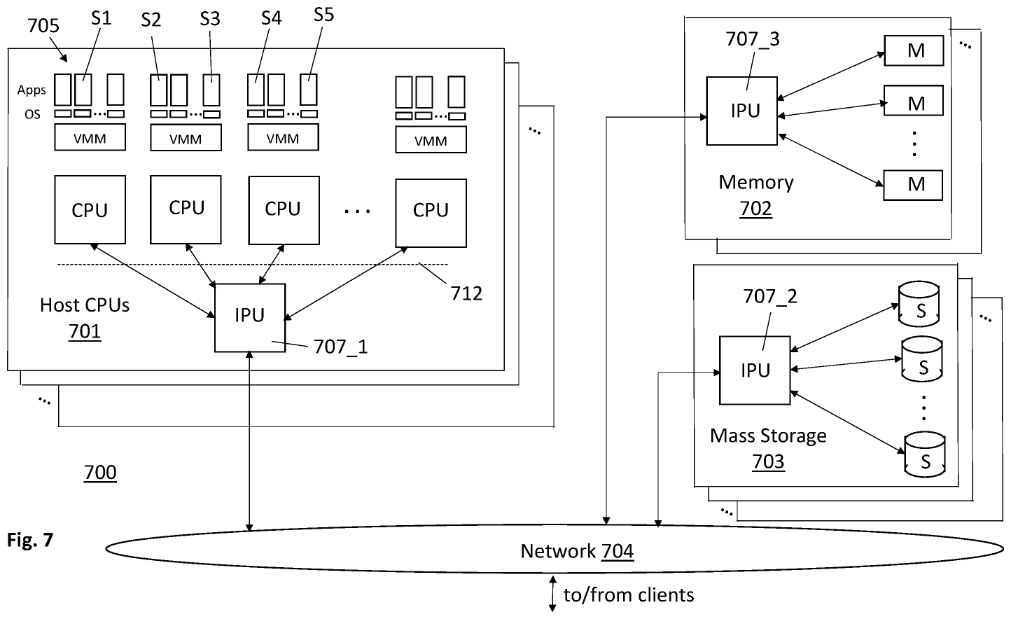

FIG. 7 shows a new, emerging data center environment in which “infrastructure” tasks are offloaded from traditional general purpose “host” CPUs (where application software programs are executed) to an infrastructure processing unit (IPU), edge processing unit (EPU), or data processing unit (DPU) any/all of which are hereafter referred to as an IPU.

Here, the aforementioned CSP primary resources and/or the aforementioned remote CSP resources located at customer locations can be implemented with one or more data centers including one or more data centers that embraces the emerging data center environment of FIG. 7.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications. A recent trend is to strip down the functionality of at least some of the applications into more finer grained, atomic functions (“micro-services”) that are called by client programs as needed. Micro-services typically strive to charge the client/customers based on their actual usage (function call invocations) of a micro-service application.

In order to support the network sessions and/or the applications' functionality, however, certain underlying computationally intensive and/or trafficking intensive functions (“infrastructure” functions) are performed.

Examples of infrastructure functions include routing layer functions (e.g., IP routing), transport layer protocol functions (e.g., TCP), encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators.

As such, as observed in FIG. 7, the infrastructure functions are being migrated to an infrastructure processing unit (IPU) 707. FIG. 7 depicts an exemplary data center environment 700 that integrates IPUs 707 to offload infrastructure functions from the host CPUs 704 as described above.

As observed in FIG. 7, the exemplary data center environment 700 includes pools 701 of CPU units that execute the end-function application software programs 705 that are typically invoked by remotely calling clients. The data center also includes separate memory pools 702 and mass storage pools 705 to assist the executing applications. The CPU, memory storage and mass storage pools 701, 702, 703 are respectively coupled by one or more networks 704.

Notably, each pool 701, 702, 703 has an IPU 707_1, 707_2, 707_3 on its front end or network side. Here, each IPU 707 performs pre-configured infrastructure functions on the inbound (request) packets it receives from the network 704 before delivering the requests to its respective pool's end function (e.g., executing application software in the case of the CPU pool 701, memory in the case of memory pool 702 and storage in the case of mass storage pool 703).

As the end functions send certain communications into the network 704, the IPU 707 performs pre-configured infrastructure functions on the outbound communications before transmitting them into the network 704. The communication 712 between the IPU 707_1 and the CPUs in the CPU pool 701 can transpire through a network (e.g., a multi-nodal hop Ethernet network) and/or more direct channels (e.g., point-to-point links) such as Compute Express Link (CXL), Advanced Extensible Interface (AXI), Open Coherent Accelerator Processor Interface (OpenCAPI), Gen-Z, etc.

Depending on implementation, one or more CPU pools 701, memory pools 702, mass storage pools 703 and network 704 can exist within a single chassis, e.g., as a traditional rack mounted computing system (e.g., server computer). In a disaggregated computing system implementation, one or more CPU pools 701, memory pools 702, and mass storage pools 703 are separate rack mountable units (e.g., rack mountable CPU units, rack mountable memory units (M), rack mountable mass storage units (S).

In various embodiments, the software platform on which the applications 705 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include applications for micro-services.

Notably, in various embodiments, one or more CSP IPU's within the CSP's remote installation on a remote customer's premises can be used to support the methodologies discussed at length above with respect to FIGS. 3 through 6. For example, an IPU (including software that executes on the IPU) within the remote CSP installation at the customer location can monitor the customer's usage of the remote CSP installation (and/or power consumption of the remote CSP installation) and inform the CSP's primary infrastructure (e.g., the resource manager 601 of FIG. 6) if/when the customer is under utilizing the remote installation (e.g., utilization and/or power consumption falls below a threshold). The IPU can proactively inform the CSP's primary infrastructure and/or respond to requests (e.g., sent by the resource manager 601 of FIG. 6). The ISP (including software that executes on the IPU) can also assist the CSP configure or otherwise setup execution of another customer's requests on the CSP installation at the customer location.

Also, at one extreme a customer other than the customer on whose premises the remote CSP infrastructure resides may be “installed” on the remote CSP infrastructure at the customer location. For example, certain specific application software programs, containers, memory space, storage and CPU processing threads/processes may be configured for the use of the other customer as a quasi-permanent setup. At another extreme, no such quasi-permanent configuration/installation exists for the other customer at the remote CSP infrastructure. Instead, the remote CSP infrastructure is used to support the other customer in an ad-hoc fashion (e.g., only one or a few micro-service functions of a larger sequence of micro-service functions that are performed in response to a request sent by the other customer to the CSP are performed with the remote CSP resources at the customer's location). The CSP can also arrange various flavors between these two extremes for the other customer, and/or, both of these extremes can concurrently be used by the CSP to service the other customer.

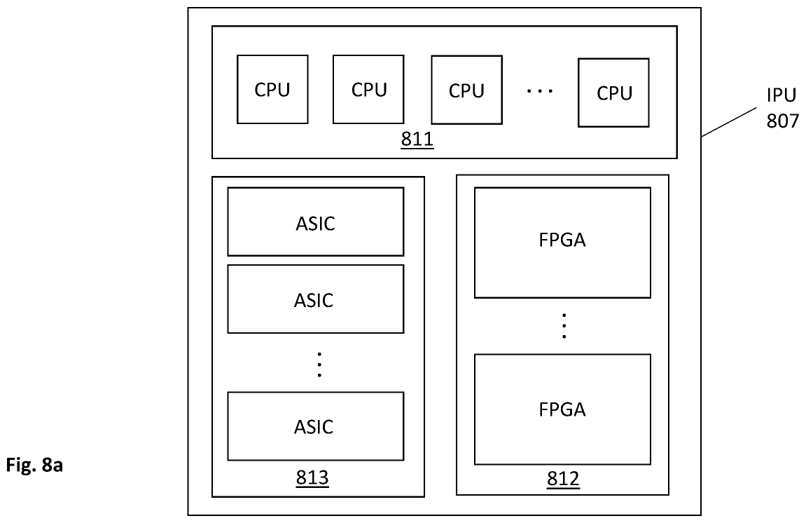

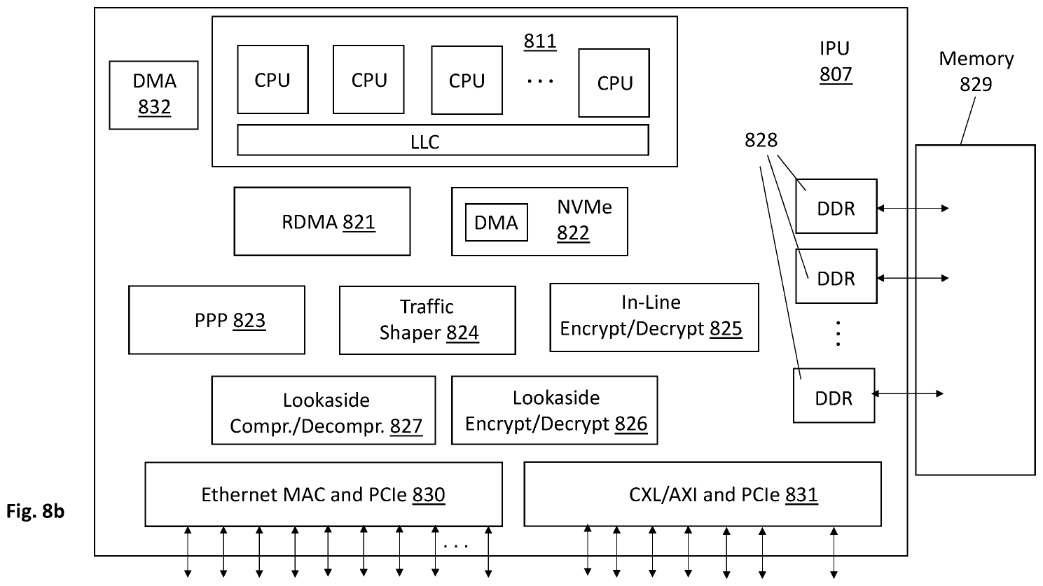

FIG. 8a shows an exemplary IPU 807. As observed in FIG. 8 the IPU 807 includes a plurality of general purpose processing cores 811, one or more field programmable gate arrays (FPGAs) 812, and/or, one or more acceleration hardware (ASIC) blocks 813. An IPU typically has at least one associated machine readable medium to store software that is to execute on the processing cores 811 and firmware to program the FPGAs (if present) so that the processing cores 811 and FPGAs 812 (if present) can perform their intended functions.

The IPU 807 can be implemented with: 1) e.g., a single silicon chip that integrates any/all of cores 811, FPGAs 812, ASIC blocks 813 on the same chip; 2) a single silicon chip package that integrates any/all of cores 811, FPGAs 812, ASIC blocks 813 on more than chip within the chip package; and/or, 3) e.g., a rack mountable system having multiple semiconductor chip packages mounted on a printed circuit board (PCB) where any/all of cores 811, FPGAs 812, ASIC blocks 813 are integrated on the respective semiconductor chips within the multiple chip packages.

The processing cores 811, FPGAs 812 and ASIC blocks 813 represent different tradeoffs between versatility/programmability, computational performance, and power consumption. Generally, a task can be performed faster in an ASIC block and with minimal power consumption, however, an ASIC block is a fixed function unit that can only perform the functions its electronic circuitry has been specifically designed to perform.

The general purpose processing cores 811, by contrast, will perform their tasks slower and with more power consumption but can be programmed to perform a wide variety of different functions (via the execution of software programs). Here, the general purpose processing cores can be complex instruction set (CISC) or reduced instruction set (RISC) CPUs or a combination of CISC and RISC processors.

The FPGA(s) 812 provide for more programming capability than an ASIC block but less programming capability than the general purpose cores 811, while, at the same time, providing for more processing performance capability than the general purpose cores 811 but less than processing performing capability than an ASIC block.

FIG. 8b shows a more specific embodiment of an IPU 807. The particular IPU 807 of FIG. 8b does not include any FPGA blocks. As observed in FIG. 8b the IPU 807 includes a plurality of general purpose cores 811 and a last level caching layer for the general purpose cores 811. The IPU 807 also includes a number of hardware ASIC acceleration blocks including: 1) an RDMA acceleration ASIC block 821 that performs RDMA protocol operations in hardware; 2) an NVMe acceleration ASIC block 822 that performs NVMe protocol operations in hardware; 3) a packet processing pipeline ASIC block 823 that parses ingress packet header content, e.g., to assign flows to the ingress packets, perform network address translation, etc.; 4) a traffic shaper 824 to assign ingress packets to appropriate queues for subsequent processing by the IPU 807; 5) an in-line cryptographic ASIC block 825 that performs decryption on ingress packets and encryption on egress packets; 6) a lookaside cryptographic ASIC block 826 that performs encryption/decryption on blocks of data, e.g., as requested by a host CPU 301; 7) a lookaside compression ASIC block 827 that performs compression/decompression on blocks of data, e.g., as requested by a host CPU 701; 8) checksum/cyclic-redundancy-check (CRC) calculations (e.g., for NVMe/TCP data digests and/or NVMe DIF/DIX data integrity); 9) thread local storage (TLS) processes; etc.

So constructed/configured, the IPU can be used to perform routing functions between endpoints within a same pool (e.g., between different host CPUs within CPU pool 701) and/or routing within the network 704. In the case of the latter, the boundary between the network 704 and the IPU's pool can reside within the IPU, and/or, the IPU is deemed a gateway edge of the network 704.

The IPU 807 also includes multiple memory channel interfaces 828 to couple to external memory 829 that is used to store instructions for the general purpose cores 811 and input/output data for the IPU cores 811 and each of the ASIC blocks 821-826. The IPU includes multiple PCIe physical interfaces and an Ethernet Media Access Control block 830, and/or more direct channel interfaces (e.g., CXL and or AXI over PCIe) 831, to support communication to/from the IPU 807. The IPU 807 also includes a DMA ASIC block 832 to effect direct memory access transfers with, e.g., a memory pool 702, local memory of the host CPUs in a CPU pool 701, etc. As mentioned above, the IPU 807 can be a semiconductor chip, a plurality of semiconductor chips integrated within a same chip package, a plurality of semiconductor chips integrated in multiple chip packages integrated on a same module or card, etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable storage medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Some possible embodiments include the following examples.

Example 1. A method including a service provider accessing data indicating that at least a portion of an information systems infrastructure that is managed by the service provider and is installed at a tenant's location to perform information services for the tenant is available to perform information services for entities other than the tenant. The method further includes the service provider providing information services to at least one of the entities with the portion of the information systems infrastructure.

Example 2. Example 1 above where the tenant and the at least one of the entities have different Internet domain names.

Example 3. Examples 1 or 2 above where respective gateways to respective networks of the tenant and the at least one of the entities have different Internet IP address network prefixes.

Example 4. Examples 1, 2 or 3 above where the information systems infrastructure is geographically remote from the service provider's primary information systems infrastructure.

Example 5. Examples 1, 2, 3 or 4 above where the recognizing is performed in response to the tenant under-utilizing the information systems infrastructure.

Example 6. Examples 1, 2, 3, 4 or 5 above wherein the recognizing is performed at least in part in response to the service provider's information systems infrastructure being deemed to be consuming excessive power.

Example 7. Examples 1, 2, 3, 4, 5 or 6 above where the portion of the information systems infrastructure comprises an accelerator.

Example 8. Examples 1, 2, 3, 4, 5, 6 or 7 above where the recognizing and providing of Example 1 are performed by an information processing unit (IPU).

Example 9. A machine readable medium containing program code that when processed by one or more processors causes the method of Examples 1, 2, 3, 4, 5, 6, 7, or 8 to be performed.

Example 10. A data center including a network, a plurality of CPUs coupled to the network, a plurality of mass storage devices coupled to the network, a plurality of accelerators coupled to the network, and, a machine readable storage medium containing program code that when processed by one or more processors causes the method of Examples 1, 2, 3, 4, 5, 6, 7, or 8 to be performed.

1. A method, comprising:
a service provider performing a) and b) below:
a) accessing data indicating that at least a portion of an information systems infrastructure that is managed by the service provider and is installed at a tenant's location to perform information services for the tenant is available to perform information services for entities other than the tenant; and,
b) providing information services to at least one of the entities with the portion of the information systems infrastructure.

2. The method of claim 1 wherein the tenant and the at least one of the entities have different Internet domain names.

3. The method of claim 1 wherein respective gateways to respective networks of the tenant and the at least one of the entities have different Internet IP address network prefixes.

4. The method of claim 1 wherein the information systems infrastructure is geographically remote from the service provider's primary information systems infrastructure.

5. The method of claim 1 wherein the recognizing is performed in response to the tenant under-utilizing the information systems infrastructure.

6. The method of claim 1 wherein the recognizing is performed at least in part in response to the service provider's information systems infrastructure being deemed to be consuming excessive power.

7. The method of claim 1 wherein the portion of the information systems infrastructure comprises an accelerator.

8. The method of claim 1 wherein a) and b) are performed by an information processing unit (IPU).

9. A machine readable storage medium containing program code that when processed by one or more processors causes a method to be performed, the method comprising:
a service provider performing a) and b) below:
a) accessing data indicating that at least a portion of an information systems infrastructure that is managed by the service provider and is installed at a tenant's location to perform information services for the tenant is available to perform information services for entities other than the tenant; and,
b) providing information services to at least one of the entities with the portion of the information systems infrastructure.

10. The machine readable storage medium of claim 9 wherein the tenant and the at least one of the entities have different Internet domain names.

11. The machine readable storage medium of claim 9 wherein respective gateways to respective networks of the tenant and the at least one of the entities have different Internet IP address network prefixes.

12. The machine readable storage medium of claim 9 wherein the information systems infrastructure is geographically remote from the service provider's primary information systems infrastructure.

13. The machine readable storage medium of claim 9 wherein the recognizing is performed in response to the tenant under-utilizing the information systems infrastructure.

14. The machine readable storage medium of claim 9 wherein the recognizing is performed at least in part in response to the service provider's primary information systems infrastructure being deemed to be consuming excessive power.

15. The machine readable storage medium of claim 9 wherein the portion of the information systems infrastructure comprises an accelerator.

16. The machine readable storage medium of claim 9 wherein a) and b) are performed by an information processing unit (IPU).

17. A data center, comprising:
a network;
a plurality of CPUs coupled to the network;
a plurality of mass storage devices coupled to the network;
a plurality of accelerators coupled to the network; and,
a machine readable storage medium containing program code that when processed by one or more of the CPUs causes a method to be performed, the method comprising:
a service provider performing a) and b) below:
a) accessing data indicating that at least a portion of an information systems infrastructure that is managed by the service provider and is installed at a tenant's location to perform information services for the tenant is available to perform information services for entities other than the tenant; and,
b) providing information services to at least one of the entities with the portion of the information systems infrastructure.

18. The data center of claim 17 wherein the wherein the tenant and the at least one of the entities have different Internet domain names.

19. The data center of claim 17 wherein respective gateways to respective networks of the tenant and the at least one of the entities have different Internet IP address network prefixes.

20. The data center of claim 17 wherein the information systems infrastructure is geographically remote from the service provider's primary information systems infrastructure.
